(19) United States
(12) Patent Application Publication
(10) Pub. No.: US 2004/0146628 A1
(43) Pub. Date: Jul. 29, 2004

(54) Method and system for preparing extraction meal from sun flower seeds for animal feed

(76) Inventor: Ulrich Walter, Mettmann (DE)

Correspondence Address: Pauley Petersen & Erickson, Suite 365, 2800 West Higgins Road, Hoffman Estates, IL, 60195, US

(21) Appl. No.: 10/474,144

(22) PCT Filed: Mar. 30, 2002
(86) PCT No.: PCT/EP02/03565

(30) Foreign Application Priority Data
Apr. 6, 2001 (DE) 101174217

(51) Int. Cl. A23L 1/20

(52) U.S. Cl. 426/630

(57) ABSTRACT

The invention relates to a method and a system for preparing waste-free extraction meal from the seeds of conventional sunflowers for animal feed for monogastrics or ruminants. The extraction meal from shell kernels and shells with adherent kernel parts is mechanically structured, chunks of extraction meal material are comminuted, kernel parts adhering to the shells are removed and the shells are coarsely comminuted while maintaining and improving the structure and the structured particles are separated into two fractions containing various amounts of crude proteins and crude fibers, one protein-rich fraction which is suitable for feeding monogastrics is obtained and one fraction containing crude fibers which is suitable for feeding ruminants is obtained, being subjected to a decomposition process in order to increase nutritive value and digestibility.

The invention relates to a method for waste-free preparation of extraction meal from sunflower seed of conventional sunflowers for animal feed, and to a system for performing the method.

Sunflower seed extraction meal is obtained in the process of obtaining sunflower oil. Sunflower seed, which is first comminuted, is de-oiled in a first pressing process to approximately 15 to 20% oil. After that, further oil is extracted in an extraction system, by heating with hot steam and adding the solvent hexane in the countercurrent process, down to a residual content of approximately 1 to 3%, and the residue that now remains is called extraction meal.

In animal nutrition, high quantities of proteins are needed, and only proteins or protein carriers of plant origin should be used. Among the possible plant protein carriers are soy, rape, sunflowers, palm kernel, other oily fruits, lupines, pod fruits such as feed peas, field beans, and residues from starch production, such as corn gluten. Among the aforementioned protein carriers, soy products make up about 50% of the market. However, a large proportion of soy products are of genetically modified origin (GMO), which is not permitted everywhere. In particular, many mixed products containing genetically modified soy (GMO) are already offered. Many consumers reject foodstuffs made with genetically manipulated raw materials, however, which means that even if foods of animal origin are produced, GMO-free raw materials must be used for feeding the animals.

In Europe, GMO-free oil seeds are cultivated, among which sunflowers are of especially great value, since their proteins have a biologically high-quality pattern of amino acids, making them highly suitable for animal feed because of their protein quality.

In the case of the sunflower extraction meal that occurs as a byproduct (waste product) in the production of oil from sunflowers also contains proteins of biologically high value, so that the sunflower extraction meal, in terms of its protein quality, is virtually equivalent to the proteins from soy extraction meal.

From the standpoint of animal nutrition, the protein bearing substances should be selected in accordance with physiological nutrition guidelines, namely

crude fiber content and digestibility/nutrient concentration

proteins in accordance with quantity, digestibility and biological value

fats, fatty acids and active ingredients

ingredients with antinutritive effect.

Taking the above criteria into account, extraction meals of soy are highly suitable for feeding monogastric animals. In terms of the crude fiber content and digestibility, extraction meals from conventional-grade sunflower seed are not so well suited for monogastric animals.

The residues—extraction meal—from oil production from sunflower seed are, however, well suited for animal feed, even because of their fatty acid pattern. In particular, sunflower seeds contain linoleic acid, an essential fatty acid, in large quantity, which in terms of this property makes it superior to soy and rape, as the following Table 1 shows:

TABLE 1
Fatty Acids in % in Oil from Sunflower Kernels:
A Comparison with Soybean Oil and Rapeseed Oil

| | Palmitic | Stearic | Oleic | Linoleic |
|---|---|---|---|---|
| | Acid | Acid | Acid | Acid |
| | C 16:0 | C 18:0 | C18:1w9 | C18:2w6 |
| Sunflower, | 4-10 | 2-6 | 10-12 | 33-77 |
| Convential Types | | | | |
| Soy | 2-14 | 2-7 | 20-36 | 48-60 |
| Rape | 1-6 | 1-3 | 11-52 | 10-36 |

Source: H. Jerosch et al. 1993, Henkel KGaA 1997

Other favorable aspects of extraction meals from sunflowers are the following:

the high physiological nutritional value of the oil in sunflower kernels. The content of essential linoleic acid (C18:2ω6) is markedly above the corresponding contents in soy and rapeseed; see Table 1.

Sunflower kernels are practically free of antinutritive substances. In contrast, soy and rape seed contain a number of active ingredients, such as trypsin inhibitors (soy) and mustard oil glycosides/glucosinolates (rape seed), some of which are even toxic. In any case, however, these active ingredients impair the nutritional value of the raw material, unless they are inactivated by a heat treatment (toasting). Unless they are gently toasted, the proteins of these raw materials are damaged and their nutritional value is lessened—which in practice is a major problem.

For the byproducts from sunflower, heat treatment is not necessary, which is favorable for the sake of protein quality.

In agriculture—in terms of the fruiting sequence—the sunflower is a valuable early fruit, which promotes the good tilth of the soil and thus promotes soil fertility.

Despite all these advantages, a botanical peculiarity of sunflower kernels is that the byproduct from processing the kernels—which is sunflower extraction meal—is usable in its conventional grade for ruminants, but is not so useful for feeding poultry and pigs.

The sunflower forms its seeds in the form of nuts—achenes. Achenes are single-seed fruits in which the kernel containing the oil and protein becomes so tightly intergrown with the fruit hull that the kernel and shell can no longer be separated smoothly and completely from one another in the shelling operation. As a consequence, the extraction meal obtained from the kernels contains not only the defatted kernel material but also a high proportion of shell fragments, to which residues of the kernel meat adhere. This shell component means that conventionally produced extraction meals from sunflower kernels—despite the high-quality proteins—do not meet the physiological nutritional demands applicable to poultry and pigs. What is decisive is the factor of “digestibility of the organic substance”. In the grades that are conventionally available, the digestibility is inadequate for the demands of poultry and pigs.

In Table 2, figures for various extraction meals are shown; the raw nutrient substances are broken down in terms of nutritional value by Weender's analysis as raw materials/ratio, and DQ stands for the digestion quotient, such that the difference between organic substance with feed and organic substance in feces yields the digestible organic substance; the numerical ratio in percent is the DQ. The figures in Table 2 are taken from L. Lennerts, 1984; K. M. Menke and W. Huss, 1987; H. Hugger, 1989; and DLG 1991/1997.

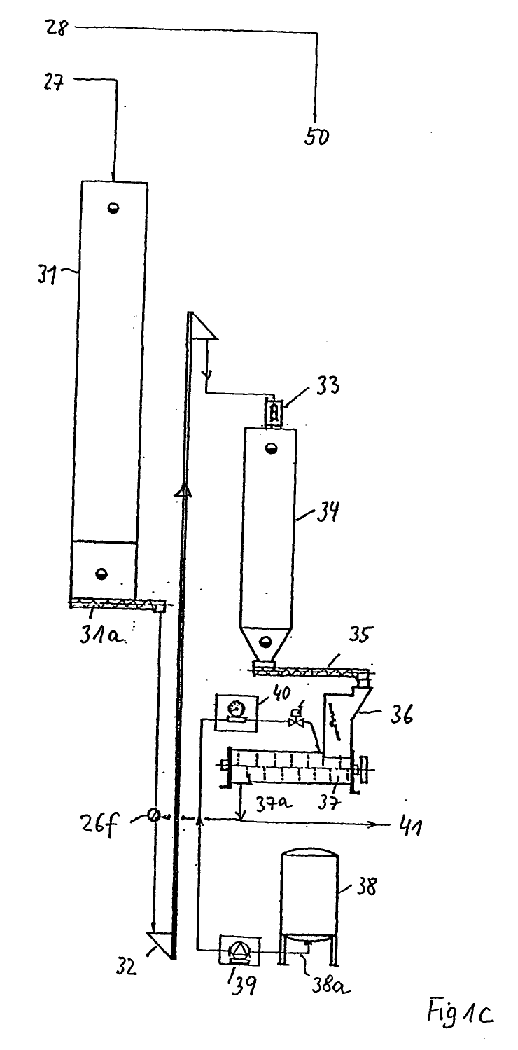

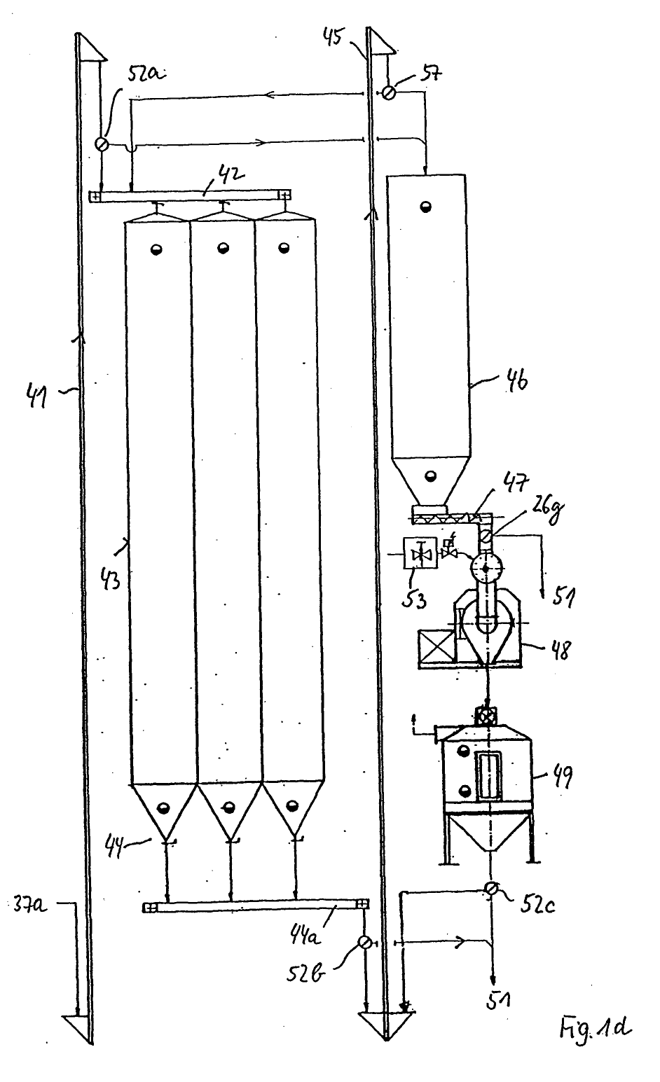

The figures in FIG. 2 document the fact that the values measured in digestibility experiments for conventional-grade sunflower extraction meals meet the requirements for ruminants, but are not adequate for pigs. The same is true for poultry, but here the current data are unavailable, since digestibility tests for poultry are not usual, for reasons of methodology. As a consequence, until now sunflower extraction meals have been included in recipes for mixed feed, which are intended for poultry and pigs, with a mixing-in rate of a maximum of 20% of the required protein carriers.

But even for ruminants, sunflower shells have such a slight digestibility (Table 2) that the organism is unable to utilize the energy of this waste material. This is due to the high content of skeletal substances, which the digestive system does not break down. However, the digestibility of sunflower shells, as well as of the stems and heads (fruit holders), can be enhanced by disintegration using lye. In this way, the organism can extract energy from the raw material, or alternatively, economy of energy carriers can be achieved. In treatment with caustic soda, the cellulose-lignin-hemicellulose complex is loosened/cleaved. As a consequence, more cellulose can be broken down by the microorganisms in the rumens, and in this way the material rich in skeletal substance is utilized for energy. The takeup of feed increases, and the rate with which the disintegrated material passes through the digestive tract is increased. The effect of the disintegration is all the more pronounced, the more strongly the skeletal substance is lignified.

TABLE 2
Extraction Meals - Crude Fiber, Crude Nutrient Substances
and Digestibility Values, All Figures in % (Rounded);
Dry Substance ≈ 88-90%

| | | | | Organic Substance Digestibility = DQ¹⁰ | | | |
|---|---|---|---|---|---|---|---|
| Oil- | Contents | | | Ruminants | | Pigs | |
| bearing | Crude | Crude | Crude | Measured | Performance | Measured | Performance |
| seed | fiber | fat | protein | Values | Demanded | Values | Demanded |
| Soybeans | 6-7 | 20-22 | 35-39 | 92 | 80-50 | 87 | 90-70 |
| Extraction | 6-7 | 1-2 | 42-45 | 91 | 80-50 | 87 | 90-70 |
| meal, | | | | | | | |
| unpeeled | | | | | | | |
| seed | | | | | | | |
| Extraction | 3-4 | 1-2 | 49-50 | 92 | 80-50 | 92 | 90-70 |
| meal, | | | | | | | |
| peeled | | | | | | | |
| seed | | | | | | | |
| Shells | 34 | 2 | 2-12 | 72 | 80-50 | 55 | 90-70 |
| Rapeseed | 6-14 | 43 | 24 | 77 | 80-50 | 71 | 90-70 |
| Extraction | 12-15 | 2 | 35 | 80 | 80-50 | 67 | 90-70 |
| Meal | | | | | | | |
| Sunflower | 19-34 | 42-52 | 22-24 | 51 | 80-50 | 62 | 90-70 |
| Kernels | | | | | | | |
| Extraction | 30-34 | 2 | 26-29 | 51 | 80-50 | (19) | 90-70 |
| meal, | | | | | | | |
| unpeeled | | | | | | | |
| seed | | | | | | | |
| Extraction | 20-22 | 2-2,4 | 34-39 | 75 | 80-50 | 46 | 90-70 |
| Meal, | | | | | | | |
| partly | | | | | | | |
| peeled | | | | | | | |
| seed | | | | | | | |
| Extraction | 13-15 | 1,5 | 40-45 | | | | |
| meal, | | | | | | | |
| peeled | | | | | | | |
| seed | | | | | | | |
| Shells | 60 | 1 | 4 | 19 | 80-50 | | |

The definitive factor for the quality of the proteins is their content of essential amino acids, namely lysine, methionine and cystine, threonine, and tryptophan. In Table 3, the limiting essential amino acids in the extraction meals are given in grams per 100 g of crude protein.

Table 3 shows that

Sunflower seed is superior to soybeans with respect to methionine and cystine;

with respect to lysine, sunflower seed ranks below soy and rape.

With respect to threonine and tryptophan, soy, rape and sunflower seed are practically of equal value.

Thus the proteins from sunflower seed come quite close to those from soy.

TABLE 3
Limiting Essential Amino Acids in Oil-Bearing Seed Meals
Figures in g/100 g of Crude Protein (CP)

| | | | | Sunflower | |
|---|---|---|---|---|---|
| | Soy | | Rape | Unpeeled- | |
| | Unpeeled-Peeled | | Unpeeled | Partly Peeled | |
| Amino Acid | 44% CP⁴⁷ | 50% CP | 35% CP | 26% CP | 35% CP |
| Lysine | 6.5 | 5.8 | 5.7 | 3.7 | 3.6 |
| Methionine | 1.5 | 1.2 | 2.2 | 1.9 | 2.3 |
| Cystine | | | 2.4 | 1.6 | 1.8 |
| Threonine | 4.0 | 3.7 | 4.5 | 3.9 | 3.7 |
| Tryptophan | 1.3 | 1.3 | 1.3 | 1.4 | 1.2 |

Source: L. Lennerts, 1984, H. Jerosch et al 1999
CP = crude protein

Since monogastric animals such as pigs and poultry can process only slight amounts of crude fiber components, the use of sunflower extraction meal of conventional origin for animal feed for monogastric animals is not usual, because of the high crude fiber content of 20% and more. Only once the proportion of crude fiber can be lowered to below the critical limit of 10% for monogastric animals, with simultaneous increase in the contents for crude protein, do extraction meals meet the requirements for these types of animals in terms of digestibility and nutrient concentration.

In the literature by Levic, Jovanka et al, “Removal of cellulose from sunflower meal by fractionation”, J. Am. Oil Chem. Soc., JAOCS, 1992, 69(9) 890-893, a method is known in which the extraction meal, specifically shells with adhering kernel meat, obtained after the sunflower seed is peeled is fractionated by straining. However, by straining alone, not all the residues of the kernel meat are detached from the shells, and a product is obtained that still contains about 30% crude protein and is intended as cattle feed. Since the proportion of the particle size up to 0.5 mm makes up 75.4% of the product obtained by straining, this is not an optimal product in terms of feed. In particular, the fat content, that is, a material contained in the kernel meat, is unchanged in the product of the above method, if the values before and after the straining are compared.

From German Patent Disclosures DE 40 34 738 A1 and DE 40 34 739 D2, methods for processing sunflower seeds by shelling before oil is recovered are known. The attempt is made by repeated peeling and sifting to separate the kernel meat from the shell and deliver the fine component to the fraction that can be used for animal feed. This is an uneconomical peeling process involving 20% shell waste, which is burned to dispose of it. It fails to create a physiologically usable or recyclable nutritional product.

Even completely detaching the kernel meat from the shell fails, so that still-usable proteins are also burned along with the waste.

In the method of German Patent Disclosure DE 37 07 541 A1, the processing of fat-rich oil seeds, such as sunflower seed, is described. The method is distinguished by the fact that drying of the tempered seeds is done, with adjustment of a water content to below 10%, by shock heating at temperatures of 100 to 150° over periods of time of up to 5 minutes. Partial coagulation of the protein can already occur, causing the digestibility of the product to suffer. Once again, this is a processing method that is done before the oil milling process; that is, it is a process of peeling sunflower seeds, and not the further processing of sunflower extraction meal that remains behind after the oil is recovered. Because of the severe protein denaturing caused by the high temperatures, the product is only conditionally usable for suitably feeding animals.

In European Patent Disclosure EP 0750845 A2, a method for disintegrating crude fiber-rich material by means of lyes is described; the lye treatment is combined with fermentation.

The object of the invention is to process sunflower seed extraction meal from conventional sunflowers for animal feed without waste, and specifically to process it for both monogastric animals and ruminants in such a way that a high-quality vegetable protein carrier is created that is approximately equivalent to soy product extraction meal. It is a goal of the invention to process the extraction meal, produced from sunflower seed from the oil recovery process, completely, or in other words without waste.

According to the invention, this object is attained with a method in which the extraction meal comprising shells, kernel parts and shells with adhering kernel parts, is comminuted and mechanically structured, and clumps of material comprising extraction meal are comminuted, the shells are separated from the adhering kernel parts, and the shells are comminuted coarsely, while preserving and improving the fiber structure, and the structured particles are separated into two fractions with different contents of crude proteins and crude fibers, in which first a protein-containing fraction with a low proportion of shell and a high crude protein content, suitable for animal feed for monogastric animals, is separated out from the structuring process, and as the remaining fraction, a crude-fiber-containing fraction with a high proportion of shell and a low crude protein content suitable as animal feed for ruminants, is obtained. Thus according to the invention, from the conventional sunflower seed extraction meal, a fraction is produced in which the content of crude protein is enriched so as to be suitable for feeding monogastric animals, while the remaining low-protein fraction is still suitable for ruminants.

The residual fraction that remains, whose content of crude protein has been reduced to very slight proportions for the sake of a very high crude protein content, which is substantially increased compared to the extraction meal originally employed, is improved in its digestibility and nutritive value by additional disintegration processes, in order to yield a usable feed for ruminants.

The essence of the invention is for sunflower extraction meal, in particular conventional-grade sunflower extraction meal, to be prepared in a special system with a suitable milling process, in such a way that the shells are separated from the kernel material. The goal is to adjust the proportion of shell in the novel products precisely, because by way of the proportion of shell, the digestibility of the organic substance can be controlled. The suitability of the product for nutrition for the various types of animal depends in turn on the digestibility of the organic substance.

So far, there has been no lack of attempts to develop methods for separating the shell from the kernel material. None of these methods has proved effective and produce products that were usable for feeding monogastric animals—that is, poultry and pigs. Hence none of these methods has gained a foothold in practice.

The method and the system according to the invention are suitable for commercial use. With the aid of this method and system, it is possible for the first time to control the proportion of shell in the extraction meal of sunflower seed so exactly that two fractions occur:

One fraction with a low proportion of shell and a high protein content; in terms of the digestible organic substance and the biological quality of the proteins, it meets the requirements for poultry and pigs. This product is of practically equal value to soy extraction meal, which is the market leader.

One fraction with a high proportion of shell and a lower protein content; this product is suitable for feeding ruminants.

In addition, in a separate method, the shells—intrinsically a waste product—are treated with lye; the skeletal substances are disintegrated, and thus even the shells are rendered usable for energy for feeding ruminants.

The method and system of the invention produce protein carriers of various grades, which are usable in practical animal feeding. These products are adjusted in terms of physiological nutrition exactly to the requirements of the various types of livestock. For the first time, a protein carrier from sunflower seed is thus available that is entirely appropriate for monogastric animals. Moreover, it is attained that the byproducts that occur in the processing of sunflower seed can be utilized completely, that is, including the shell wastes, in animal feed.

The invention succeeds in creating a product from renewable resources, namely sunflowers, and in particular one-year-old plants, which are rich in fat and proteins, in two quality levels, or grades, by means of suitable refinement of the extraction meal that occurs in the recovery of the oil.

According to the invention, a technologically high-value industrial manufacturing process is created, with a mechanical treatment process of the feed material, namely extraction meal, that treats the product gently, is safe and reliable in operation, and does not involve excessively great material heating, so that all the natural ingredients are preserved undamaged. Feed material that is intrinsically pure is obtained, and specifically, valuable resources for livestock are obtained from sunflower extraction meal by means of a non-polluting, energy-saving, economical method for preparation and nutritional value improvement, with increased digestibility.

Advantageous refinements of the method of the invention can be learned from claims 2-6. In particular, it is proposed that the particles of the extraction meal be comminuted before the straining, then separated by particle sizes, and from the particle size fraction having the larger-volume particles, that those particles be separated taking their specific weight into account by means of wind sifting; the individual method steps and sequences of method steps are repeated at least once and in particular multiple times, before the particles separated off are discharged from the treatment process and delivered to the respective fraction to be formed, namely one that is either rich in crude protein or rich in crude fiber.

The lighter-weight particles obtained by means of the wind sifting are formed essentially by shell parts (husks) and are removed by suction and collected as a fraction containing a high crude fiber content of over 15%, while the particles with the higher specific weight are formed essentially by the kernel particles or kernel particles with adhering shells and are separated out by gravity, and optionally pass through a further method cycle and are collected as a fraction containing a high crude protein content of over 40%.

According to the invention, a crude protein-rich fraction with a proportion of crude protein over 40% and a crude fiber content below 10%, which is approximately equivalent in composition to a soy extraction meal and suitable for feeding monogastric animals, can be obtained by treatment and separation.

In a refinement of the crude-fiber-containing fraction with a proportion of crude fibers of at least 15%, it is proposed that this fraction then be subjected to lye disintegration, in particular by means of caustic soda, as a result of which the energy value and the digestibility of the material are increased, making it even better-suited for feeding ruminants.

In particular, it is proposed that the crude-fiber-containing fraction be disintegrated in a two-stage process, in which in the first stage, a first stream of material from the fraction is wetted with liquid caustic soda and mixed, and then mixed intensively with a second stream of material from the fraction and homogenized, and after that, optionally after intermediate storage, in a second stage, the prepared mixture is delivered to a conditioner with steam additionally added for the sake of tempering and increasing the moisture in the mixture, and then in a press, at a press temperature of approximately 40 to 65° C. is pressed into pellets, and the pellets obtained are then cooled down to room temperature while maintaining approximately the same moisture content.

The method according to the invention of treating, structuring and refining conventional sunflower extraction meal and preparing two different fractions of different composition is preferably effected in a closed system; it is performed continuously by means of suitable control and regulation and storage using intermediate tanks, to prevent the parts of the equipment, including the conveyor tracks connecting the individual parts of the equipment to one another, which operate by gravity or compressed air or suction, from running empty.

A system for performing the method of structuring and refining the sunflower extraction meal to obtain two fractions of different grades and quantities includes at least two successive combinations of a strainer device, a wind sifter, and a fan with a separator with a discharge gate, and each strainer device is connected to the associated wind sifter for transporting the large-volume particles that do not pass through the strainer and is connected to the next strainer device, for carrying away the smaller-volume particles that do pass through the strainer, by means of connecting lines. At least the second and every subsequent strainer device additionally has a beater device that is movable in its interior, and each wind sifter is connected to an associated fan and separator via a suction extraction line for extracting the large-volume, specifically lightweight particles containing crude fiber by suction, and the lightweight particles removed by suction can be delivered, via the discharge gate to a collecting tank for the crude-fiber-containing fraction via connecting lines. Moreover, a turbo separator is provided, to which the air-exhaust lines of the fans are connected. From the outlet of each wind sifter, except for the last wind sifter, one connecting line leads to a comminuting device; the outlet of the last strainer device and the outlet of the last wind sifter have direct connecting lines to the respective collecting tank for the fraction containing protein and for the fraction containing crude fiber, respectively, and the outlet of the comminuting device communicates with the inlet of the first strainer device via a conveying direction, for re-circulating the material that has not yet been sufficiently structured.

Advantageous refinements of the system can be learned from the definitive characteristics of claims 8-20.

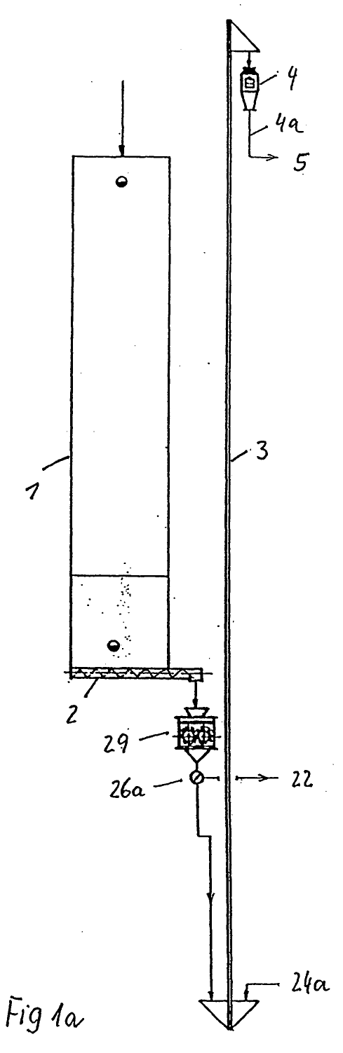

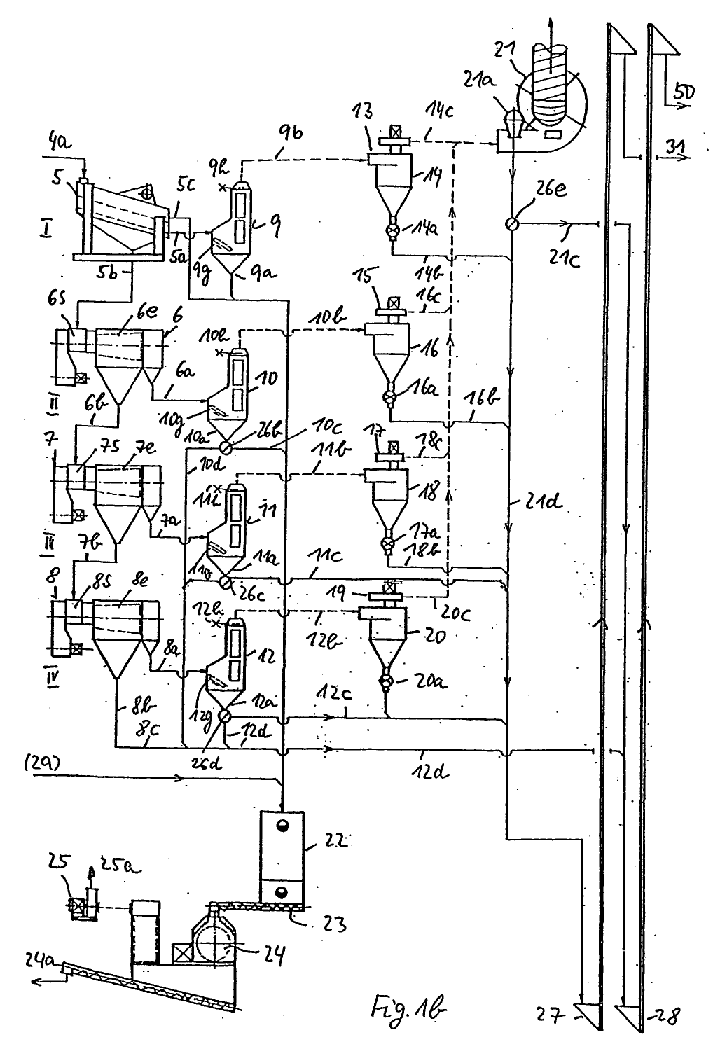

The advantageous refinements and the embodiments according to the invention of the system for preparing two fractions of different quality and quantity, on the one hand for feeding monogastric animals and on the other for feeding ruminants, from sunflower extraction meal will be described below in conjunction with a system schematically shown in FIGS. 1a and 1d.

With the system of the invention, the extraction meal that is obtained as a residue in recovering oil from sunflower seed is further processed and is processed completely into two fractions that are fully usable for animal feed. Sunflower extraction meal has a bulk weight of about 300 to 350 kg/m³, while the sunflower seed itself still has a bulk weight of about 400 to 440 kg/m³. To obtain an animal feed for monogastric animals, the extraction meal must not only be given a finer, farina-like structure, but the crude protein content must also be raised to above 40%, while the crude fiber content is lowered to the lower limit of less than 10%. To make the sunflower extraction meal suitable as animal feed for ruminants, a coarse structure should be preserved, yet a substantially greater fiber breakdown should be achieved, and an improvement in the digestibility of the sunflower shells should be attained, especially by means of lye disintegration. A production system of compact modular design that can be adapted to particular local conditions in terms of its size is schematically shown in FIGS. 1a, 1b, 1c, 1d; the processing method and preparation method of the two fractions can take place in a closed system. The materials are fed, for instance from one apparatus or station to the next, via pipes, worms, bucket and chain conveyors and elevators.

The process sequence begins with the storage tank 1 for sunflower extraction meal, which is equipped with a monitoring system for reporting full and empty states. The storage capacity is designed for the particular product output desired and includes a supply for at least 24 hours, in order to assure uninterrupted, continuous production. The storage tank is provided on the outlet side with a metering worm 2 for discharging the material; the metering worm has a continuously variable drive mechanism for the sake of a uniform discharge of material in an adjustable quantity.

The sunflower extraction meal that is available for processing, of the kind furnished as a waste product from the oil mill, is subject to severe fluctuations in the composition of raw material, with different proportions of clumps of material. The sunflower extraction meal discharged continuously from the discharge worm 2 is therefore delivered directly to a device 29 for breaking up clumps, which is equipped with grinders and a strainer insert, through which the finely comminuted material falls. For further processing, the material is delivered to a first two-way valve box 26a and is directed either to the preliminary tank 22 of the comminuting device 24, in the form of a special mill, or via the elevator 3, through the magnet separator 4, to the first station of the strainer device 5.

The discharge material or extraction meal is conveyed to the first station, that is, the strainer device 5, by means of a feeder device, such as the elevator 3, that comprises a cup-type conveyor system mounted on a rubber belt. Shortly upstream of the entrance into the strainer device 5 via a travelling pipe 4a, a tubular magnet 4 is incorporated into the pipe, with a magnet core, for secure separation out of metal, for metal particles that may be contained in the extraction meal. The material stream is divided in the tubular magnet and is carried to the metal separator via the conical magnet core disposed in the interior. A double magnet core, with the strong magnetic fields, exerts a strong adhesion force, so that iron contaminants are removed with certainty.

Several method stages then follow for structuring, that is, comminution and separation from the kernel parts adhering to the shells, and sifting of the particles contained; each method stage includes a strainer device, a wind sifter, fans, and separators with gates.

The first strainer device 5, at which the material conveyed from the storage tank 1 arrives, is embodied as a shaking screen and can be adjusted in its inclination to between 5 and 17°. It has an ejection angle and makes uniform distribution of material over the full width of the strainer possible; practical adaptation of the demands for strainer precision is possible. The first strainer device 5, as a double-decker shaking screen, is equipped with two strainer inserts disposed one above the other and spaced apart, and also has cleaning by means of rubber bulls, which guarantees that the strainer mesh will remain unclogged and at the same time increases the quality of the sifted material.

The upper strainer system of the first strainer device 5 forms a first separating passage, in which the coarse particles of the shell, including adhering kernel particles, pass through the uppermost strainer and are fed via the connecting line 5c directly to the preliminary tank 22 of the comminuting device 24.

The second, lower strainer insert in turn forms a separation passage for the material that passes through the first strainer insert. Medium-sized shell parts and coarse kernel components of the same size do not pass through the second strainer insert; instead, they are discharged again at the end of the lower strainer insert and reach the associated wind sifter 9 via the connecting line 5a. In the wind sifter 9, the particles are separated by specific weight, in such a way that the heavy kernel parts, as well as shell parts with adhering kernel material, are discharged downward by gravity from the wind sifter for further handling and are delivered in turn, via the connecting line 9a, 9c, to the preliminary tank 22 for the comminuting device 24. The specifically lightweight shell parts of the same size, which essentially contain crude fiber, are conversely extracted by suction from the wind sifter by the following fan 13 and separator 14 via the suction extraction line 9b and are conveyed via the discharge gate 14a and connecting line 14b of the separator into a connecting line 21d to a feeder device 27, such as the elevator 27, to the collecting tank 31 for further processing. This involves the shell particles that essentially now contain only crude fiber, that is, essentially a crude-fiber-containing fraction, which is collected in the collecting tank 31 and is intended for ruminants.

The present system includes four method stages I, II, III, IV, each of which includes one strainer device 5, 6, 7, 8, one wind sifter 9, 10, 11, 12, and one fan 13, 15, 17, 19 with a separator 14, 16, 18, 20 and a discharge gate 14a, 16a, 18a, 20a. The strainer machine and the wind sifter represent a combination for two different types of separating the particles, in which lightweight particles, shells, and husks of various specific weights are extracted by suction from the granular extraction meal in the individual passages—or method stages. The particles that each reach the associated wind sifter 9, 10, 11, 12 from the associated strainer device 5, 6, 7, 8 through the connecting line 5a, 6a, 7a, 8a are carried, via an adjustable inlet and via a vibration channel 9g, 10g, 11g, 12g, into the wind sifter 9, 10, 11, 12 in a uniform product curtain over the full width into the wind sifter. An adjustable air valve 9h, 10h, 11h, 12h regulates the wind intensity and air quantity, setting precisely the appropriate values for the particular product in the applicable passage. Separating out the lightweight particles and husks containing crude fiber is done by suction extraction from the wind sifter in accordance with their specific weight. The separation limit can be adapted to requirements at any-time during operation. Both the product stream and the air speed and air throughput can be regulated continuously variably. Each wind sifter with its own air supply is assigned a low-pressure fan 13, 15, 17, 19, including a cyclone separator 14, 16, 18, 20 and discharge gate 14a, 16a, 18a, 20a, for uninterrupted suction extraction of the husks from the wind sifter and separation in the appropriate cyclone, and in this case the husks are discharged via the discharge gate and transported onward selectively. The waste air from the wind sifters and the cyclone separators moves through connecting lines 14c, 16c, 18c and 20c, which are united, into the common turbo separator 21 for cleaning.

The turbo separator 21 has versatile uses and replaces the conventional cyclones. It can be accommodated in the tiniest space, with large air quantities. The separator is maintenance-free, since there are no moving parts. The mixture of air and dust is forced by the fans 13, 15, 17, 19 into the turbo separator 21 and carried into its wormlike housing. Because of the shape of the housing, the air is set into rotation, and the dust components are thrown against the inner wall of the housing and carried, with a partial air stream, through a gaplike opening into the downstream separator 21a. The nearly dust-free primary air stream that flows past the gap moves past the laminations. As a result of the sudden change in this case in the direction of motion of the air stream, the remaining dust is carried back into the rotating stream. The downstream separator functions in principle like a cyclone and comprises a central tube, cyclone head, and cylindrical jacket. In the cyclone, the air is introduced at a tangent. The dust separated out here is carried away with excess air. The degree of separation achieved by the turbo separator is substantially higher than in conventional cyclones, for the same minimal and maximal air volume.

The material that drops through the second strainer in the first strainer device 5, which is in the form of coarser and fine material including husks and has already been presorted by particle size, is delivered to a downstream strainer device 6 via the connecting line 5b. What falls through each strainer machine 5, 6, 7, 8 is delivered to a respective downstream strainer machine 6, 7, 8 via the corresponding connecting lines 6b, 7b.

The strainer devices 6, 7, 8 of stages II, III and IV that follow the first strainer device 5 serve to sift out the extraction meal from the husks, and in particular also serve to detach the kernel parts from the shells by means of the beater device and brushes. The strainer devices 6, 7, 8 each have an inlet funnel for the material arriving via the connecting lines 5b, 6b, 7b. By means of a feed worm 6s, 7s, 8s, the material is brought into the interior of a conical strainer basket, in which a beater cross 6e, 7e, 8e rotates, this cross being equipped with turbulence strips that make the strained material turbulent over the entire circumference as they pass through the strainers. Brushes are also disposed on the circumference at the beater cross and assure freedom from clogging of the strainer mesh and good separation between fine and coarse parts. The possibility exists of using different-sized holes in the mesh, adapted to the desired particle size in each strainer passage 6, 7, 8. The strainer baskets can be changed within only a few minutes, without requiring any mechanical parts to be removed.

The connecting lines 5c, 9c, 10c, 11c are united before reaching the preliminary tank 22.

The strainer device 5 of the first stage I has two separation passages, namely the upper and lower strainers; the strainer device 6 forms a third separation passage. The material of the same particle size but different specific weights that reaches the wind sifting system via the connecting line 6a is separated in accordance with the specific weights in the wind sifter 10; the specifically lightweight shell parts of equal size are extracted by suction via the downstream fan 15 and separator 16 and are carried via the discharge gate 16a for further processing to the collecting tank 31, via the connecting line 16b, 21d of the conveyor track 27. The heavier particles, which essentially include the protein-rich kernel particles, are conversely discharged from the wind sifter (10) via the outlet 10a and can be delivered selectively either to the preliminary tank 22 of the comminuting device 24 by means of a valve box 27b via the connecting line 10c or, already as an end product, via the connecting line 10d, 12d of the conveyor track 28, such as an elevator, and from there to a collecting tank 50 for the protein-rich fraction for collecting the protein-rich particles, and this fraction forms the end product for monogastric animals.

The connecting lines—that is, discharge lines 14b, 16b, 18b, 20b and 12c—and the line 21d arriving from the downstream separator 21a downstream of the flap 26e are united before leading to the feeder device 27 that leads to the collecting tank 31. The connecting lines 21c, 8c, 12d, 11d, 10d, which lead to the feeder device 28, are likewise united.

It is also possible for the particles that fall out from the third wind sifter 11 to be delivered via the valve box 26b and the connecting line 11c directly to the connecting line 21d to the collecting tank 31, instead to the comminuting device 22, 24.

When there is a variable product particle size and a separate, regulatable air supply, the same systematic separation of material occurs in the following stepwise process sequence. The fourth and fifth separation passages are realized with the strainer devices 7 and 8, which with the wind sifters 11 and 12, the fans 17 and 19, separators 18 and 20 with discharge gates 18a and 20a in stages III and IV, which are constructed just like stage II.

Downstream of each of the wind sifters 10, 11, 12 are respective valve boxes 26b, 26c, 26d, to each of which two connecting lines 10c, 10d; 11c, 11d; 12c, 12d are connected on the outlet side, and these connecting lines make it possible to control the discharge product selectively by its nature, either returning it to the structuring process again for further comminution and sifting, or depending on its nature carrying it to the collecting tanks 50 and 31 for the two different fractions.

The waste air is forced into the turbo separator 21 by the fans 13, 15, 17 and 19.

In the turbo separator, the dust is also separated out of the mixture of air and dust, and the cleaned, dust-free air is pumped out into the open. The dust that occurs runs out of the downstream separator 21a selectively via a valve box 26e and depending on the quality is carried either via the line 21c to the conveyor track 27 to the collecting tank 31 for the crude-fiber-containing fraction for ruminants, or via the line 21d to the conveyor track 28 into the collecting tank 50 for the protein-rich fraction for monogastric animals.

With this first part of the system and of the preparation process, the sunflower extraction meal is prepared industrially to suit the requirements for animal feed for monogastric animals and ruminants and is separated into two fractions. The kernel parts adhering to the shell are detached gently; clumps of material are structured and comminuted by means of the device for breaking up clumps, and the sunflower shells are coarsely comminuted, while preserving and improving the fiber structure, even taking into account the fluctuations in raw material of different types.

The particles from the separation sifting in the strainer devices and wind sifters, which run together and are located in the preliminary tank 22, are delivered by means of a metering worm 23, which has a continuously variable drive mechanism, to the mill 24 in a uniform flow of material. The preliminary tank 22 is equipped with a full and empty sensor and assures the uninterrupted material supply for the metering worm 23. The preparation passage, with various technical devices for processing, includes a special mill 24 of balanced grinding plate construction with fluted impact plates and thus suitable grinding technology and preparation operations with a variable circumferential rotor speed, so that a uniform structure of the end product is achieved, and at the same time, in the passage through the equipment, the remaining kernel parts are separated from the shell parts, and the kernel parts are comminuted in the grinding process, so as to obtain a pourable product of farina-like ground structure with a range of particle size suitable for monogastric animals. The large number of small particles and the shape increases the specific service area in particular and improves the nature, which is a further advantageous improvement in digestibility of the particles for monogastric animals; the range of particle size is between 700 and 200 μm using analysis strainers per ISO DIN 4188. By means of the choice of the mill strainer insert with certain perforated plates and a large strainer area, the fiber structure of the coarse shells is improved, and thus the absorption properties are also improved. The effect of the slightly broken-fiber shell parts offers further advantages in the ensuing process of lye disintegration of the crude-fiber-containing fraction.

The ground structure is decisive for the quality of the end product for ruminants. The comminuting system, which at the same time is a preparation system, is equipped with an aspiration system, which prevents the generated air excess pressure in the grinding chamber; it includes a fan and an attached filter 25. In this way, the material is carried away faster and does not rotate with the air. Thus a desired uniform structure of the ground product is achieved.

The extraction meal component from the overflow of the strainer separation passages of the strainer devices, after passing through the last structuring-preparation passage out of the mill 24 via a discharge feed worm 24a, reaches a feeder device 3, such as an elevator, back to the first separation passage of the first strainer device 5 and passes once again through the preparation process of stages I-IV.

In the collecting tank 50, the protein-rich kernel material, with now only slight proportions of shells—crude fiber—is collected into a fraction of farina-like structure, which is usable directly as animal feed for monogastric animals.

Conversely, the fraction with a substantially higher crude fiber content that is collected in the collecting tank 31, and that is intended for ruminants, can then be subjected to further refinement and improvement to increase the energy value and nutritive value, by means of a disintegration of the crude fibers. The process of preparation and lye disintegration for this crude-fiber-containing fraction, which was separated out in the first part of the system, is adapted to this material. The lye disintegration process can be performed in one stage or two stages. In the one-stage process, the reaction time is relatively long. The two-stage process is preferred. In the two-stage process, the disintegration of the crude fibers, in particular the husks and shell particles, in conjunction and combination with a pelleting process, is improved, and by means of pressure, friction and temperature, self-heating occurs in the pellets, which substantially shortens the reaction time of the lye process and at the same time reduces the required quantity of lye as well. Better bulk properties of the thus-treated material, a reduction in volume because of the pelleting, simple product storage, the absence of demixing of material, and favorable transportation costs are all attained.

Moreover, it is also possible, in addition to the collected crude-fiber-containing fraction, also to process even such ballast components as sunflower heads and stems, which additionally increase the energy value of this feed for ruminants. These ballast components, in suitably comminuted condition, can for instance be delivered directly to the collecting tank 31.

The extraction meal, or the shell parts contained in it, have already been preprocessed by the extraction process in the oil mill, in the course of which the wax jacket of the sunflower seed has been altered, and the wax is no longer present. The wax component and the solvent, hexane, are in the recovered oil mixture for further processing. The sunflower extraction meal fraction from the preparation system, which is well structured in the mechanical treatment process described at the outset, is located in the collecting tank 31, which assures continuous, reliable and safe operation of the entire system. The collecting tank 31 regulates an unpredicted interruption in production, possibly even over several hours. Both the production process and the machines are designed to provide uninterrupted operation over many days. The collecting tank 31 is equipped with a full and empty sensing control system, for monitoring the content of material. The discharge worm 31a operates discontinuously to fill the preliminary tank 34 with material by means of the elevator 32 and is triggered automatically by the full and empty sensor of the preliminary tank 34. A strong tubular magnet 33, constructed like the tubular magnet 4, is also located at the preliminary inlet-metering tank, in order once again to remove any iron particles that are present from the animal feed.

The preliminary tank 34, including the full and empty sensor for monitoring production, communicates on the outlet side with the discharge metering worm 35, which is regulatable with a frequency controller, for continuous, uniform feeding to the flow weighing scales 36, where the solid material is weighed and the product quantity is detected continuously as a guide value for the dosage of lye.

For wetting with lye, a lye sprayer and turbulence mixer 37 is provided, with three mixing stages; it has adjustable mixing tools and a split inlet, for mixing solids homogeneously with liquids. With the continuous turbulence mixing process, it is possible to produce a homogeneous mixture among the particles and the lye for the lye disintegration. The crude-fiber-containing fraction, obtained from the sunflower extraction meal, is fed in a curtain to the mixing cylinder and split into two material streams. The required quantity of liquid caustic soda is fed continuously under process control and precisely to the first stream of material. This stream of material, enriched with liquids, is already united in the first mixing stage of the turbulence mixer with the remaining solid quantity, that is, the second material stream. Because of this two-stage mixing, an intensive mixing process is attained. In the second mixing zone or dwell zone, the intensive mixing occurs. Compared to the first mixing zone, the material speed is reduced. In the third mixing zone, the material speed is increased again, and a final intensive homogenization is achieved.

The lye is metered fully automatically under process control. From a main lye tank 38, which is provided with a barrier valve 38a, the lye is metered in automatically and exactly by means of a metering pump, connected directly to the tank, with an overpressure valve 39. The metering is effected with automatic, exact quantity regulation via a motor-driven metering valve, with detection of the flow rate and remote display via a magnetic inductive counter 40. The precision metering equipment is designed for precise admission of the tiniest quantities, for instance from 0.5 to 10% and in this case preferably 3 to 5% caustic soda, in terms of the material to be wetted in the turbulence mixer, and this lye is sprayed in superfine distribution and mixed in.

Downstream of the lye spraying and turbulence mixing system, the thus-wetted material is discharged from the turbulence mixer 37 via the connecting line 37a and carried, via a conveyor system by means of an elevator 41 and a bucket and chain conveyor 42, into a production silo 43 or selectively, via the two-way valve box 52a, directly to a preliminary tank 46 to the pelleting system. The production silo or dwell silo 43 for instance comprises three drop cells as well as full and empty material sensors, and is provided with three pneumatic drain slides 42. Per spacing cell, the holding capacity is equivalent for instance to the daily production output with three shifts in 24-hour operation. Depending on the nature of the crude fiber structure, the dwell times can selectively be extended to from 10 to 75 hours of temporary storage, in order to achieve the greatest possible lye disintegration of the treated crude fiber particles, before the material is delivered for pelleting.

The crude fiber mixture obtained after the lye disintegration can then be delivered to the second stage of the disintegration process, which is performed in conjunction with a pelleting process.

The mixture is conveyed onward out of the dwell silo 43 by means of pneumatic silo drain slides 44, via a bucket and chain conveyor 44a, to an elevator 45 and from there is carried into a very large press preliminary tank 46, which is equipped with full and empty sensors for the material. The holding capacity of the preliminary tank is equivalent for instance to a pressing capacity of 10 hours.

Another method option for performing the two-stage process for disintegrating the crude-fiber-containing fraction is for the mixture leaving the turbulence mixer 37 to be delivered via the feed line 37a by means of the valve box 52a, past the dwell silo, directly to the press preliminary tank 46 and not to be fed to the dwell silo 43 via an elevator 45 until after the pelleting process. During the pelleting process in the pressing operation, strong material friction of the fraction to be pelleted occurs in the pressing die, and this produces increasing product heating along with high pressure. Keeping the friction, temperature, pressure and material moisture constant during the pressing operation has a mechanically effective effect in lye disintegration of the pretreated crude-fiber-containing fraction. Consequently the digestibility of the crude fibers for ruminants is enhanced. This purposeful increase in nutritional value and a yield of raw materials are of increasing significance.

The raw-fiber-containing mixture prepared in the first stage of the disintegration process in the turbulence mixing method in the turbulence mixer 37 is discharged from the press preliminary tank 46 via the metering worm 47 and delivered to the conditioner 48, specifically with a uniform delivery of material. To further improve the fiber structure and the disintegration process, an additional steam metering device 53 with a predetermined automatic temperature system is provided, which cooperates with the conditioner. The goal is to attain only a slight increase in moisture in the material as well as the best possible constant temperature in the material before the pressing operation. In the conditioner as well, the material is subjected to turbulence mixing, and the steam metered in penetrates and is distributed uniformly in homogenized fashion. This brings about an improvement in the material to be produced, together with the lye disintegration process for the crude-fiber-containing fraction. The conditioner is equipped with a plastic inner lining, which means low power consumption and prevents material from baking on and sticking and also offers insulation against heat loss. The steam metering device 53 includes a filter, steam dryer, and pressure reducer. The regulating valve is triggered by the automatic temperature system. The delivery of steam can be interrupted by a magnetic barrier valve. By means of the hydrothermal action of the conditioning operation, a further absorption of the liquid lye in the material is achieved. This optimal intensive preprocessing contributes substantially to the subsequent lye disintegration of the crude fiber components in the pelleting press. The material—pressing product—is distributed from the conditioner purposefully over the entire annular die surface area of the press by forced feeding. A pelleting press with an annular die surface is provided in which there are bores in the die into which the pressing material is forced by means of pressure rollers. In this process, compacting simultaneously occurs. The pellets thus produced are still at an elevated temperature in the range from 40 to 65° C. They are therefore then cooled down gently to room temperature in a cooling device 49. The cooling device is embodied for instance as a countercurrent round cooler and makes gentle, uniform cooling adapted to the product possible. The pellets are distributed uniformly at the inlet over the entire cooling surface, so that uneven cooling of the product does not occur. Level sensors are fixed to the minimal and maximal dwell times; a pilot sensor prevents overfilling with product from occurring. If the pellets produced are then delivered to the dwell silo again for storage for a further reaction time, then it is necessary that the pellets be cooled down accordingly. For effective cooling by the countercurrent principle, the important factors are a balanced ratio of the air quantity, air speed and dwell time, and low mechanical stress on the pellets. The pellets leave the die at a temperature of approximately 50° C., for instance. It is important to bring the pellets gently to the temperature that should be near the ambient temperature, with only the least possible extraction of moisture. This is advantageously done by means of cooling by the countercurrent principle. The pellets produced in the pellet press 48 are delivered continuously via a delivery gate to the cooling device 49, and distributed over the entire surface. The cooling air fan is built in in the hood.

The hood shape thus assures a uniform flow of cooling air. The fan is always operated economically, adapted to climatic conditions and the throughput. The stably constructed cooling room has a large inspection door with a glass viewing port. Adjustable material sensors are installed on it, and with them the throughput and the cooling time are predetermined. The triggering of the sensors is done automatically by a control system not shown here. The discharge mechanism is driven by a pneumatic or hydraulic system. This means low energy costs and little expense for maintenance. The discharge capacity can be adjusted in continuously variable fashion. The further feeding of the cooled-down pellets downstream of the cooling device is done via a valve box 52c, either directly to the final warehouse 51 or, via an elevator 55 and valve box 57, to the dwell silo 43 with drop cells. From the drop cells, after the requisite dwell time, that is, the preselected, variable drop time, has elapsed, the final product can be carried directly to the final warehouse or to a shipping place 51 via the respective pneumatic drain slides 44 by means of a discharge chain conveyor 44a via the valve boxes 52b. The final product thus produced is a final product containing crude fiber, and specifically a crude-fiber-containing extraction meal of sunflower seed that has been disintegrated and has a high energy value and is suitable for feeding ruminants.

It is also possible for the crude-fiber-containing fraction obtained, having small proportions of kernel parts and intended for ruminants, to be delivered—without lye treatment—from the collecting tank 31 directly to the elevator 41 via the discharge feed worm 31a and the two-way valve box 26f, via a connecting line, not shown.

If pelleting of the obtained fractions is not desired, the material collected in the press preliminary tank 46 can be fed directly to the final warehouse 51 for ruminants via a feed line, via the metering discharge worm 47 and the two-way valve box 26g.

According to the invention, it is successfully possible by mechanical preparation and disintegration processes to prepare sunflower extraction meal into a valuable animal feed, specifically in two categories, namely a protein-rich fraction which is approximately equivalent to a soy extraction meal and is suitable for monogastric animals, and a crude-fiber-containing refined fraction that is suitable for ruminants.

The novel feed components from sunflower extraction meal that can be attained according to the invention are a pure, natural food. The production systems can be constructed in the regions where they are needed. The products can be processed at the very site where sunflowers grow.

The two fractions obtained according to the invention by processing sunflower extraction meal can now also be further processed industrially into mixed feed, on the basis of recipes that contain nutrients and active ingredients in dosages as defined in the required standards for use in accordance with types of animal and performance classes. The fractions obtained according to the invention from sunflower extraction meal can be used in the form of economical, high-quality feed and as a replacement for soy products, while avoiding GMO products. Some model calculations follow for mixed feed, based on current German raw material prices.

The most important measurement data of the raw materials for comparative calculation are the contents of protein and energy. In protein carriers, soy extraction meal, the market leader, serves as a measurement standard for the alternative products. With the aid of linear programming, the optimal recipe for the mixed feed—that is, a recipe based on the selection of economical raw materials that simultaneously meets the required standards—can be calculated by the following criteria:

Required standards per type of animal and performance class

Measurement data for the contents of nutrient and active ingredients in the raw materials

Market prices of the raw materials.

The use of the protein-rich fraction, obtained by the method of the invention, in mixed feed recipes for laying hens and for pigs will now be explained below. The following model calculations and Tables 4-7 show that the novel product for sunflower extraction meal fraction 1 as a protein carrier is equivalent for poultry and pigs to the market leader, soy extraction meal, if the BVO aspect is ignored. Conversely, sunflower extraction meal fraction 1 that is intrinsically GMO-free is more favorable in price by more than 10%, if GMO-free soy extraction meal is calculated for comparison. For the sake of greater clarity, the essential data for the calculations in Tables 4-7 are summarized in Table 8. The conclusions are as follows:

The products—mixed feed for laying hens and for pigs—are comparable in their physiological nutrition value on the basis of soy extraction meal and sunflower extraction meal fraction 1; that is, the contents of protein and the limiting amino acids are within the range of the required standards for both protein carriers.

Sunflower extraction meal fraction 1 is—assessed on the basis of its nutrient contents—competitive in price with the soy extraction meal available on the market.

Sunflower extraction meal fraction 1—a product that is intrinsically GMO-free—is, however, substantially more economical if GMO-free soy extraction meal is used for comparison.

TABLE 8
Summary of Tables 4-7

| | | | | |
|---|---|---|---|---|
| | Crude | | | Price/100 |
| Type of | Protein | Lysine | Methionine | kg in |
| mixed feed | in % | in % | in % | Euros |

Laying
hens, exclusive feed

| | | | | |
|---|---|---|---|---|
| Protein | 16.50 | 0.82 | 0.39 | 15.01 |
| carrier: | | | | |
| soy | | | | |
| Protein | 16.50 | 0.82 | 0.39 | 16.97 |
| carrier: | | | | |
| GMO-free | | | | |
| soy | | | | |
| Protein | 16.50 | 0.75 | 0.37 | 15.01 |
| carrier: | | | | |
| sunflowers | | | | |
| fraction 1 | | | | |

Pig, mast feed (35 kg LW and above)

| | | | | |
|---|---|---|---|---|
| Protein | 16.50 | 0.85 | 0.26 | 13.58 |
| carrier: | | | | |
| soy | | | | |
| Protein | 16.50 | 0.85 | 0.26 | 15.54 |
| carrier: | | | | |
| GMO-free | | | | |
| soy | | | | |
| Protein | 16.50 | 0.85 | 0.30 | 13.89 |
| carrier: | | | | |
| sunflowers | | | | |
| fraction 1 | | | | |

Summary: The calculations document the fact that the novel product, sunflower extraction meal fraction 1, produced from conventional sunflower extraction meal, is suitable for feeding monogastric animals and can compete with commercially available soy extraction meal. In comparison with GMO-free soy extraction meal, sunflower extraction meal fraction 1 is markedly more favorable in price.

TABLE 4
Recipe and nutrient contents - exclusive feed for laying
hens; protein carrier: soy extraction meal, 43% protein

| | | Price in | Price in |
|---|---|---|---|
| | Proportion | Euros/100 kg | Euros/100 kg |
| Raw materials | in % | (dt) | (dt) |
| Corn | 44.64 | 13.23 | 13.23 |
| Wheat | 10.00 | 11.19 | 11.19 |
| Wheat bran | 5.00 | 8.14 | 8.14 |
| Soy | 20.27 | 19.59 | |
| extraction meal 43% | | | |
| Soy | 20.27 | | 21.55 |
| extraction meal 43% | | | |
| GMO-free* | | | |
| Fat | 4.26 | 29.50 | 29.50 |
| Alfalfa | 6.00 | 9.66 | 9.66 |
| flour 20% | | | |
| Calcium | 7.36 | 2.29 | 2.29 |
| carbonate | | | |
| Salt NaCl | 0.31 | 9.16 | 9.16 |
| Dicalcium | 1.69 | 22.89 | 22.89 |
| phosphate 40 | | | |
| Methionine | 0.14 | 295.05 | 295.05 |
| Premix | 6.00 | 9.66 | 9.66 |
| Vitamins + | | | |
| trace elements | | | |
| Σ | 100 | 15.01 | 15.41 |

| Measurement data for Nutrients | Unit | Content |
|---|---|---|
| Dry substance | % | 88.84 |
| Crude protein | % | 16.50 |
| Crude fat | % | 6.89 |
| Crude fiber | % | 4.37 |
| Crude ash | % | 12.30 |
| Energy (convertible for poultry*) | MJ/kg | 11.20 |
| Lysine | % | 0.82 |
| Methionine | % | 0.39 |

TABLE 5
Recipe and nutrient contents - exclusive feed for laying
hens; protein carrier: soy extraction meal, 43% protein

| | | Price in |
|---|---|---|
| | | Euros/100 kg |
| Raw materials | Proportion | (dt) |
| Corn | 45.68 | 13.23 |
| Wheat | 10.00 | 11.19 |
| Wheat bran | 5.00 | 8.14 |
| Sunflower* | 20.08 | 20.06 |
| extraction meal 43% | | |
| Fat | 3.80 | 29.50 |
| Alfalfa | 6.00 | 9.66 |
| flour 20% | | |
| Calcium | 7.96 | 2.29 |
| carbonate | | |
| Salt NaCl | 0.31 | 9.16 |
| Dicalcium | 0.51 | 22.89 |
| phosphate 40 | | |
| Lysine HCL | 0.26 | 152.61 |
| Methionine | 0.06 | 295.05 |
| Premix | 6.00 | 9.66 |
| Vitamins + | | |
| trace elements | | |
| Σ | 100 | 15.01 |

| Measurement data for Nutrients | Unit | Content |
|---|---|---|
| Dry substance | % | 89.15 |
| Crude protein | % | 16.50 |
| Crude fat | % | 6.61 |
| Crude fiber | % | 4.85 |
| Crude ash | % | 11.80 |
| Energy (convertible for poultry*) | MJ/kg | 11.20 |
| Lysine | % | 0.75 |
| Methionine | % | 0.37 |

TABLE 6
Recipe and nutrient contents - mast feed for
pigs (35 kg live weight (LW) and above); protein
carrier: soy extraction meal, 43% protein

| | | Price in | Price in |
|---|---|---|---|
| | | Euros/100 kg | Euros/100 kg |
| Raw materials | Proportion | (dt) | (dt) |
| Wheat | 15.00 | 11.19 | 11.19 |
| Barley | 30.79 | 10.68 | 10.68 |
| Corn | 19.00 | 13.23 | 13.23 |
| Rye | 5.00 | 10.17 | 10.17 |
| Wheat bran | 8.28 | 8.14 | 8.14 |
| Soy | 17.62 | 19.59 | |
| extraction meal 43% | | | |
| Soy | 17.62 | | 21.55 |
| extraction meal 43%, | | | |
| GVO-free | | | |
| Soy bean oil | 0.10 | 50.00 | 50.00 |
| Molasses | 1.00 | 7.12 | 7.12 |
| (beets) | | | |
| Dicalcium | 0.49 | 30.52 | 30.52 |
| phosphate 50 | | | |
| Calcium | 1.33 | 2.29 | 2.29 |
| carbonate | | | |
| Salt NaCl | 0.33 | 9.16 | 9.16 |
| Lysine HCL | 0.08 | 152.61 | 152.61 |
| Premix | 1.00 | 101.75 | 101.75 |
| Vitamins + | | | |
| trace elements | | | |
| Σ | 100 | 13.59 | 13.94 |

| Measurement data for Nutrients | Unit | Content |
|---|---|---|
| Dry substance | % | 87.32 |
| Crude protein | % | 16.50 |
| Crude fat | % | 2.39 |
| Crude fiber | % | 4.35 |
| Crude ash | % | 6.10 |
| Energy (convertible for poultry*) | MJ/kg | 12.60 |
| Lysine | % | 0.85 |
| Methionine | % | 0.26 |

TABLE 7
Recipe and nutrient contents - mast feed for
pigs (35 kg live weight (LW) and above); protein
carrier: soy extraction meal, 43% protein

| | | Price in |
|---|---|---|
| | | Euros/100 kg |
| Raw materials | Proportion | (dt) |
| Wheat | 15.00 | 11.19 |
| Barley | 32.80 | 10.68 |
| Corn | 18.00 | 13.23 |
| Rye | 5.00 | 10.17 |
| Wheat bran | 7.48 | 8.14 |
| Sunflower* | 17.34 | 19.59 |
| extraction meal 43% | | |
| Soy bean oil | 0.10 | 50.00 |
| Molasses | 1.25 | 7.12 |
| (beets) | | |
| Calcium | 1.32 | 2.29 |
| carbonate | | |
| Salt NaCl | 0.30 | 9.16 |
| Lysine HCL | 0.39 | 152.61 |
| Premix | 1.00 | 101.75 |
| Vitamins + | | |
| trace elements | | |
| Σ | 100 | 13.89 |

| Measurement data for Nutrients | Unit | Content |
|---|---|---|
| Dry substance | % | 87.61 |
| Crude protein | % | 16.50 |
| Crude fat | % | 2.48 |
| Crude fiber | % | 4.75 |
| Crude ash | % | 5.66 |
| Energy (convertible for poultry*) | MJ/kg | 12.60 |
| Lysine | % | 0.85 |
| Methionine | % | 0.30 |

1. A method for waste-free preparation of extraction meal from sunflower seed from conventional sunflowers for animal feed, characterized in that the extraction meal comprising shells, kernel parts and shells with adhering kernel parts, is comminuted and mechanically structured, and clumps of material comprising extraction meal are comminuted, the shells are separated from the adhering kernel parts, and the shells are comminuted coarsely, while preserving and improving the fiber structure, and the structured particles are separated into two fractions with different contents of crude proteins and crude fibers, in which first a protein-containing fraction with a low proportion of shell and a high crude protein content, suitable for animal feed for monogastric animals, is separated out of the structuring process, and the remaining fraction, a crude-fiber-containing fraction with a high proportion of shell and a low crude protein content suitable as animal feed for ruminants, is obtained.

2. The method of claim 1, characterized in that the particles of the extraction meal are comminuted, are separated by particle sizes by means of straining, and from the particle size fraction having the larger-volume particles, the particles are separated taking their specific weight into account by means of wind sifting, and the individual method steps and sequences of method steps are repeated at least once and in particular multiple times.

3. The method of claim 1 or 2, characterized in that the lighter-weight particles obtained by means of the wind sifting are formed essentially by shell parts (husks) and are removed by suction and collected as a fraction containing a high crude fiber content of over 15%, and the particles with the higher specific weight are formed essentially by the kernel particles or kernel particles with adhering shells and are separated out by gravity, and optionally pass through a further method cycle and are collected as a fraction containing a high crude protein content of over 40%.

4. The method of one of claims 1-3, characterized in that a crude protein-rich fraction with a proportion of crude protein of over 40% and a crude fiber content of less than 10% is obtained, which is suitable for feeding monogastric animals, and a crude-fiber-containing fraction with a proportion of crude fibers of at least 15% is obtained, which is subsequently subjected to lye disintegration, in particular by means of caustic soda, to increase the energy value (digestibility).

5. The method of one of claims 1-3, characterized in that the crude-fiber-containing fraction is subjected to a two-stage process for disintegrating of the crude fibers, and the disintegration of the husks and shell particles is improved by lye disintegration in conjunction and combination with a pelleting process, in which by pressure, friction and increasing the temperature during the pressing, self-heating in the pellets is brought about, which shortens the reaction time of the lye process.

6. The method of claim 5, characterized in that the crude-fiber-containing fraction is disintegrated in a two-stage process, in which in the first stage, a first stream of material from the fraction is wetted with liquid caustic soda and mixed, and then mixed intensively with a second stream of material from the fraction and homogenized, and after that, optionally after intermediate storage, in a second stage, the prepared mixture is delivered to a conditioner with steam additionally added for the sake of tempering and increasing the moisture in the mixture, and then in a press, at a press temperature of approximately 40 to 65° C. is pressed into pellets, and the pellets obtained are then cooled down to room temperature while maintaining approximately the same moisture content.

7. A system for continuously performing the method of one of claims 1-6, including a storage tank (1) with a metering worm (2) for uniform, regulatable-quantity discharging of the extraction meal into a device (29) for breaking up clumps and finely comminuting the extraction meal, and subsequently, by means of at least two successive combinations of a strainer device (5, 6, 7, 8), a wind sifter (9, 10, 11, 12), and a fan (13, 15, 17, 19) with a separator (14, 16, 18, 20) with a discharge gate (14a, 16a, 18a, 20a), and each strainer device is connected to the associated wind sifter for transporting the large-volume particles that do not pass through the strainer and is connected to the next strainer device, for carrying away the smaller-volume particles that do pass through the strainer, by means of connecting lines (5a, 6a, 7a, 8a; 5b, 6b, 7b, 8b), and at least the second and every subsequent strainer device (6, 7, 8) additionally has a beater device (6e, 7e, 8e) that is movable in its interior, and each wind sifter (9, 10, 11, 12) is connected to an associated fan (13, 15, 17, 19) and separator (14, 16, 18, 20) via a suction extraction line (9b, 10b, 11b, 12b) for extracting the large-volume, specifically lightweight particles containing crude fiber by suction, and the lightweight particles removed by suction can be delivered, via the discharge gate (14a, 16a, 18a, 20a) and connecting lines (14b, 16b, 18b, 20b) to a collecting tank (31) for collecting to form the crude-fiber-containing fraction, and a turbo separator (21) is provided, from which one connecting line (21d) moves to the collecting tank (31), and the air-exhaust lines (14c, 16c, 18c, 20c) of the fans (13, 15, 17, 19) lead to the turbo separator (21), and furthermore, from the outlet (9a, 10a, 11a) of each wind sifter (9, 10, 11), except for the last wind sifter (12), a connecting line (9c, 10c, 11c) leads a common comminuting device (22-25) for the crude-protein-containing particles including kernel parts, and the outlet (8b) of the last strainer device (8) and the outlet (12a) of the last wind sifter (12), via a two-way valve box (26d), have connecting lines (12d and 12c, respectively), to the collecting tank (50) for the protein-containing fraction and the collecting tank (31) for the crude-fiber-containing fraction, respectively, and the outlet (24a) of the comminuting device (22-25) communicates with the inlet to the first strainer device (5) via a feeder device (3).

8. The system of claim 7, characterized in that it forms a closed system and can be operated continuously, and the particles are conveyed from one station to the next by means of feeder devices or in pipes.

9. The system of one of claims 7 or 8, characterized in that the device (29) for breaking up clumps in the extraction meal is equipped with grinders and a strainer insert.

10. The system of one of claims 7-9, characterized in that the first strainer device (5) has two strainer inserts, and the first strainer insert traps the coarse particles, which can be delivered directly to the comminuting system (22-25), and the second strainer insert traps a further portion of larger-volume particles, which are delivered to the first wind sifter (9), in which a separation by specific weight is performed, and the specifically lightweight particles, in particular the shell particles containing crude fiber, are aspirated into the connecting line (9b) by the following fan (13) and separator (14) and are delivered, via the discharge gate (14a) and connecting line (14b), to the collecting tank (31) for the crude-fiber-containing fraction.

11. The system of one of claims 7-10, characterized in that the wind sifters (9, 10, 11, 12) are each equipped with a vibration channel (9g, 10g, 11g, 12g) for the particles arriving from the strainer device, and an air valve (9h, 10h, 11h, 12h) for regulating the air quality and the suction extraction power by means of suction extraction of the specifically lighter-weight parts, in particular the shell parts (husks), from the vibration channel, and the particles that remain in the vibration channel are discharged by gravity and can be delivered in turn via the connecting lines (9c, 10c, 11c) to the comminuting device (22-25).

12. The system of claim 11, characterized in that the separation limit, based on the specific weights of the particles that reach the vibration channel of the wind sifter, is adjustable by means of regulating the suction extraction power.

13. The system of one of claims 7-12, characterized in that the turbo separator (21), which removes the waste air by suction from the wind sifters and fans/separators via the air-exhaust lines, has a wormlike housing with a primary corridor, and via a gap in the primary corridor, a downstream separator for the lightweight particles containing crude fiber that are entrained in the waste air is connected, which leads to the collecting tank (31) via an extraction line (21d).

14. The system of one of claims 7-13, characterized in that the straining machines (6-8) following the first strainer device (5) have a conical strainer basket, inside which a rotating beating cross (6e, 7e, 8e) with turbulence strips and brushes is disposed on the circumference.

15. The system of one of claims 7-14, characterized in that a mill (24) with a plurality of impact plates and a variable circumferential rotor speed is provided as the comminuting device, for separating the kernel parts from the shell parts and comminuting them and for obtaining a pourable product.

16. The system of one of claims 7-15, characterized in that one flap (26b, 26c, 26d) is provided at each outlet (10a, 11a, 12a) of the wind sifters (10, 11, 12), in order to connect the outlet selectively with the connection line (10c, 11c, 12c) for further treatment or a connection line (10d, 11d, 12d) to the collecting tank (50) for the protein-containing fraction.

17. The system of one of claims 7-16, characterized in that a preparation system (33-40) for disintegrating the crude-fiber-containing fraction by means of caustic soda is disposed downstream of the collecting tank (31) for the crude-fiber-containing fraction and includes a turbulence mixer, with which a regulatable metering worm for charging with the fraction and a regulatable metering device with a sprayer for the caustic soda communicate.

18. The system of claim 17, characterized in that on the outlet side of the turbulence mixer for the fraction, a connecting line can be fed selectively via a valve box (52a) to a storage silo (43) or a pellet pressing system (46-49) with inlet tanks (46), and a further feed line is also provided from the storage silo (43) to the pressing system (46-49).

19. The system of claim 18, characterized in that the pelleting system includes a conditioner (48), into which the fraction from the inlet tanks (46) can be introduced, regulated via a metering worm (47), and the conditioner (48) furthermore communicates with a steam metering device (53) with a predetermined automatic temperature system, and a pelleting press with a ring matrix is provided, which is fed from the conditioner, and a cooling device for gentle cooling of the pellets is disposed downstream of the pelleting press.

20. The system of one of claims 7-19, characterized in that a continuous, fully-automatic operation of the system is provided, by means of the storage tank (1) on the inlet side for the extraction meal, collecting tank (31) for the crude-fiber-containing fraction, storage silos (43) for the crude-fiber-containing fraction, and inlet tanks (22) that store a supply for the comminuting device, inlet tanks (34) for the turbulence mixer, and inlet tanks (46) for the pelleting system, as well as driven, regulatable feed devices, including measuring instruments for the fill levels of the tanks that contain material.
